(19) United States
(12) Patent Application Publication
(10) Pub. No.: US 2026/0237079 A1
(43) Pub. Date: Aug. 13, 2026

(54) INFORMATION PROCESSING APPARATUS, INFORMATION PROCESSING METHOD, AND NON-TRANSITORY RECORDING MEDIUM

(71) Applicant: NEC Corporation, Tokyo (JP)

(72) Inventor: Kosuke YOSHIMI, Tokyo (JP)

(73) Assignee: NEC Corporation, Tokyo (JP)

(21) Appl. No.: 19/153,351

(22) PCT Filed: Feb. 14, 2023
(86) PCT No.: PCT/JP2023/004981

§ 371 Date: Aug. 4, 2025

(51) Int. Cl. G06T 7/20; G06T 7/70; G06V 40/20; H04N 23/61; H04N 23/67

(52) U.S. Cl. CPC G06T 7/20; G06T 7/70; G06V 40/25; H04N 23/61; H04N 23/675; G06V 2201/07

(57) ABSTRACT

An information processing apparatus including: an acquisition unit that acquires gait information indicating a gait of a target that moves; and a control unit that estimates a speed of the target in case the target arrives at a predetermined location based on the gait information, and controls an imaging environment for imaging the target having arrived at the predetermined location in accordance with the speed.

### TECHNICAL FIELD

This disclosure relates to the technical field of information processing apparatus, information processing methods, and recording media.

### BACKGROUND ART

Patent Literature 1 describes a technology for acquiring multiple captured images during an exposure period in accordance with multiple exposure patterns under the control of an exposure control unit, detecting the amount of blur in the captured images, creating a function based on the amount of blur and the exposure patterns, applying the function to the captured images to produce multiple corrected images, and combining the multiple corrected images.

Patent Literature 2 describes a technology for shooting images that can be switched quickly and seamlessly to high-speed shooting while shooting at a normal frame rate, by switching to high-speed shooting before the switch, using a shutter that can secure the same amount of exposure as before the switch even during the exposure time that can be secured during high-speed shooting, and transitioning to the exposure time that can be secured during high-speed shooting.

Patent Literature 3 describes a camera that includes an imaging unit for shooting a measurement target, a motion amount and position calculation unit for calculating the amount of motion and position of the imaging unit when the imaging unit is shooting the measurement target, and a motion blur amount calculation unit for calculating the amount of motion blur in the image taken by the imaging unit of the measurement target based on the amount of motion and position of the imaging unit, the amount of motion blur indicating the state of motion blur in the image captured by the imaging unit of the target being measured based on the three-dimensional shape, the amount of movement, and the position of the target being measured, and a correction image output unit that calculates the amount of correction for motion blur from the amount of motion blur calculated by the blur amount calculation unit and corrects the motion blur in the image using the calculated amount of correction for motion blur.

Patent Literature 4 describes an image correction apparatus comprising a pixel array in which pixels are arranged on a matrix, an iris recognition unit that extracts iris information used in iris recognition processing from image data obtained from the pixel array by photoelectric conversion, and a control apparatus for setting imaging conditions for obtaining image data for iris recognition processing using information obtained in the process of extracting iris information.

Patent Literature 5 describes a technology for appropriately imaging a subject, comprising acquisition means for acquiring a plurality of images of a subject imaged at different timings, estimation means for estimating the movement of the subject based on the plurality of images, and changing means for changing the setting value of an imaging section for imaging a specific part of the subject in accordance with the movement of the subject.

### CITATION LIST

### Patent Literature

Patent Literature 1: JP2011-109619A
Patent Literature 2: JP2013-085279A
Patent Literature 3: JP2018-033039A
Patent Literature 4: WO2018/198690A1
Patent Literature 5: WO2021/229761A1

### SUMMARY

It is an example object of this disclosure to provide an information processing apparatus, an information processing method, and a recording medium that are intended to improve the techniques/technologies disclosed in Citation List.

### Solution to Problem

An information processing apparatus according to an example aspect includes: an acquisition unit that acquires gait information indicating a gait of a target that moves; and a control unit that estimates a speed of the target in case the target arrives at a predetermined location based on the gait information, and controls an imaging environment for imaging the target having arrived at the predetermined location in accordance with the speed.

An information processing method according to an example aspect includes acquiring gait information indicating a gait of a target that moves; estimating a speed of the target in case the target arrives at a predetermined location based on the gait information; and controlling an imaging environment for imaging the target having arrived at the predetermined location in accordance with the speed.

A recording medium according to an example aspect is a recording medium on which a computer program that allows a computer to execute an information processing method is recorded, the information processing method including acquiring gait information indicating a gait of a target that moves; estimating a speed of the target in case the target arrives at a predetermined location based on the gait information; and controlling an imaging environment for imaging the target having arrived at the predetermined location in accordance with the speed.

### BRIEF DESCRIPTION OF DRAWINGS

FIG. 1 is a block diagram illustrating a configuration of an information processing apparatus according to this disclosure.

FIG. 2 is a diagram showing an example of a situation in which an information processing apparatus is applied.

FIG. 3 is a block diagram illustrating a configuration of an information processing apparatus according to this disclosure.

FIG. 4 is a flowchart illustrating a flow of an information processing operation of an information processing apparatus according to this disclosure.

FIG. 5 is a block diagram illustrating a configuration of a recognition system according to this disclosure.

FIG. 6 is a flowchart illustrating a flow of an information processing operation of a recognition system according to this disclosure.

FIG. 7 is a block diagram illustrating a configuration of a recognition system according to this disclosure.

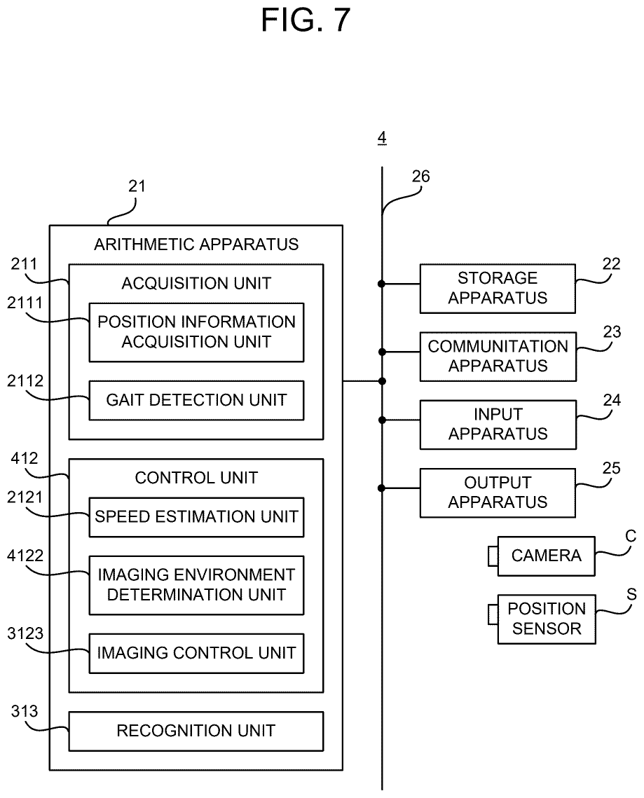

FIG. 8 is a block diagram illustrating a configuration of a recognition system according to this disclosure.

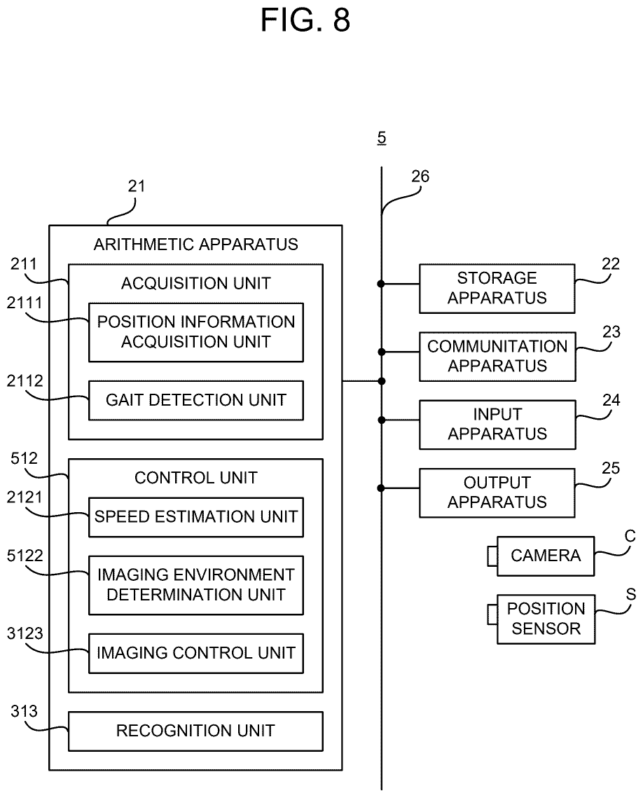

FIG. 9 is a block diagram illustrating a configuration of an information processing apparatus according to this disclosure.

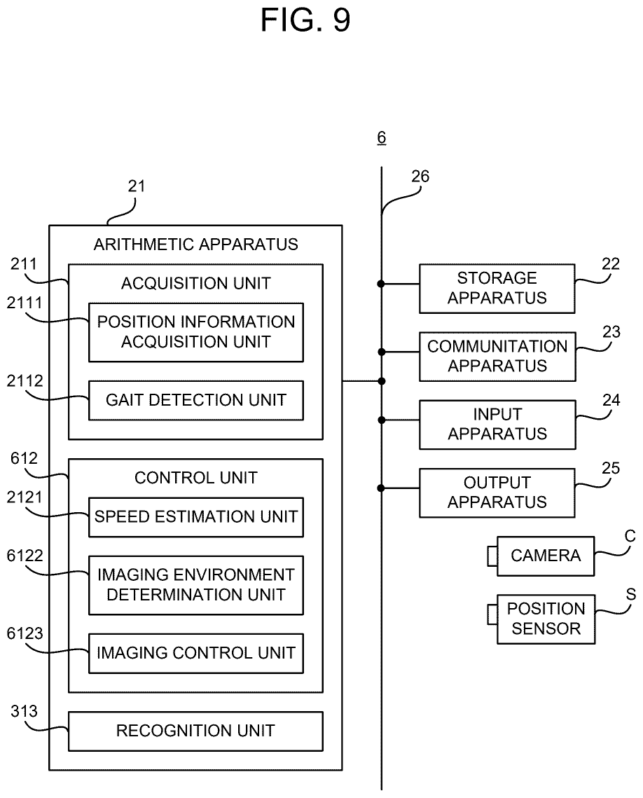

FIG. 10 is a block diagram illustrating a configuration of an information processing apparatus according to this disclosure.

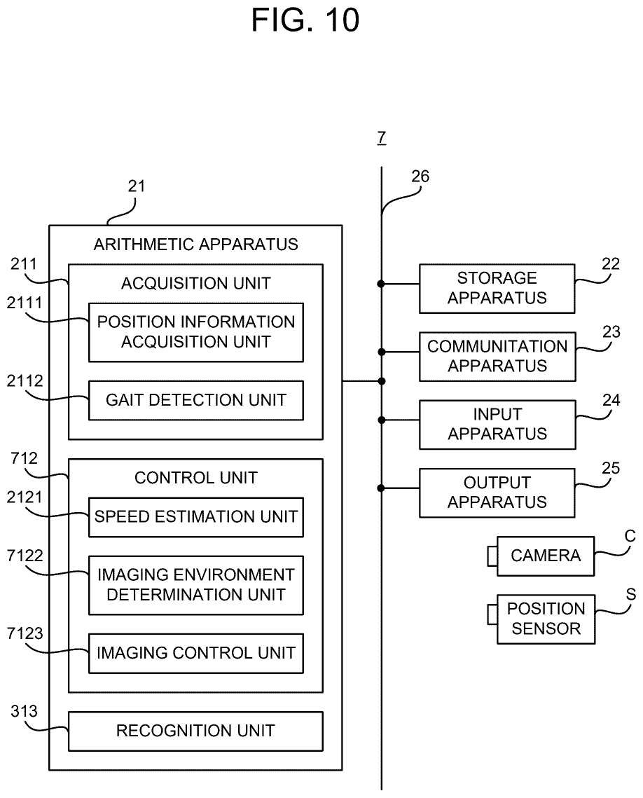

FIG. 11 is a block diagram illustrating a configuration of an information processing apparatus according to this disclosure.

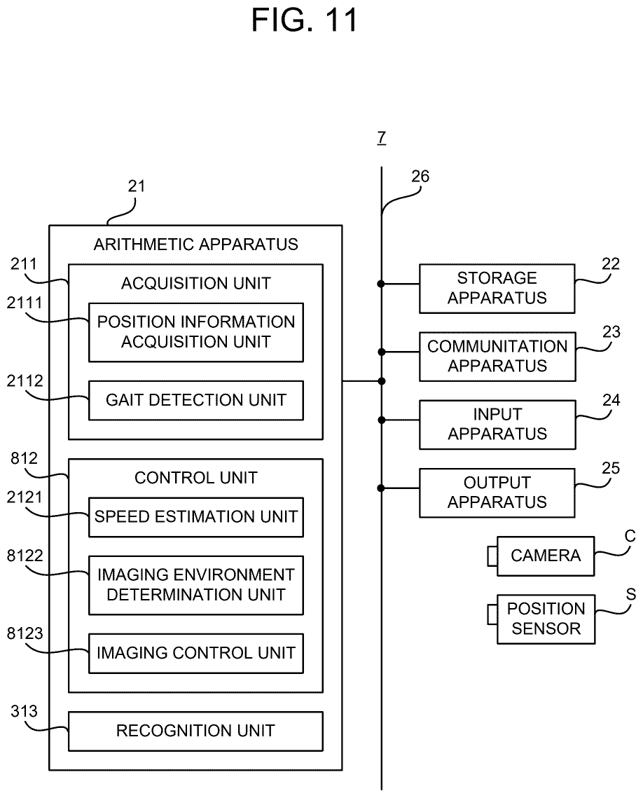

### DESCRIPTION OF EXAMPLE EMBODIMENTS

The following describes embodiments of the information processing apparatus, the information processing method, and the recording medium with reference to the drawings.

### 1: First Example Embodiment

A first embodiment of an information processing apparatus, information processing method, and recording medium is described. The first embodiment of the information processing apparatus, information processing method, and recording medium will be described below using an information processing apparatus 1 to which the first embodiment of the information processing apparatus, information processing method, and recording medium is applied.

### [1-1: Configuration of the Information Processing Apparatus 1]

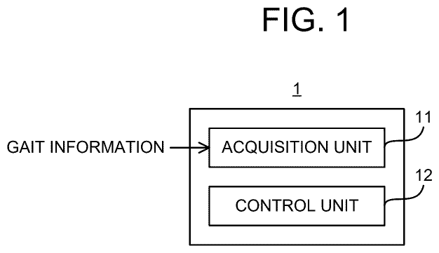

FIG. 1 is a block diagram showing the configuration of the information processing apparatus 1 according to the first embodiment. As shown in FIG. 1, the information processing apparatus 1 includes an acquisition unit 11 and a control unit 12.

The acquisition unit 11 acquires gait information indicating a gait of a target that moves. The control unit 12 estimates a speed of the target in case it arrives at a predetermined location based on the gait information, and controls an imaging environment for imaging the target that has arrived at the predetermined location according to the speed estimated.

### [1-2: Technical Effects of the Information Processing Apparatus 1]

The information processing apparatus 1 according to the first embodiment estimates the speed of the target in case the target arrives at the predetermined location and controls the imaging environment for imaging the target that has arrived at the predetermined location according to the speed estimated, thereby enabling acquisition of an image with image quality suitable for the purpose of use.

### 2: Second Example Embodiment

Next, a second embodiment of the information processing apparatus, information processing method, and recording medium will be described. The second embodiment of the information processing apparatus, information processing method, and recording medium will be described using an information processing apparatus 2 to which the second embodiment of the information processing apparatus, information processing method, and recording medium is applied.

### [2-1: Motion of an Image Capture Target and Motion Blur]

In case the image capture target moves during capturing by an imaging system such as a camera, blur may occur in a captured image acquired by capturing. In other words, in case the image capture target that moves is captured, blur may occur in the captured image. The blur that occurs in case capturing the image capture target that moves is referred to as motion blur.

Specifically, motion blur occurs in case, during capturing, the image capture target has a velocity component in a direction perpendicular to the optical axis of the imaging system. Imaging by the imaging system can also be described as the period during which the imaging elements of the imaging system are exposed.

The desired image quality varies depending on the intended use of the image. Therefore, the treatment of motion blur varies depending on the intended use of the image. For example, in case the captured image is desired to appear as in case the image capture target is stationary, it may be preferable to avoid motion blur. On the other hand, in case the motion of the image capture target is intended to be expressed, it may be preferable to include motion blur.

In this embodiment, the imaging environment may be an environment related to the brightness during imaging. In this case, control of the imaging environment may be control of the brightness during imaging. The imaging environment may be an environment related to light during imaging. The imaging environment may be an environment related to the amount of light (hereinafter referred to as “exposure amount”) received by the imaging element of the imaging system during imaging. In this case, control of the imaging environment may be control of the exposure amount during imaging. In other words, the concept of ‘brightness’ used in this embodiment and the concept of “brightness” as perceived by the human eye are not necessarily the same. The control of the imaging environment may involve controlling at least one parameter related to the amount of light received by the imaging elements, such as exposure time, frame rate, illumination intensity, aperture value, or gain. The control of the imaging environment may also involve controlling a combination of two or more parameters related to exposure quantity.

By controlling the imaging environment of the imaging system, motion blur can be controlled. The movement of the image capture target during image capture by the imaging system may be rephrased as the movement of the image capture target during the exposure time of the imaging system. Therefore, for example, by increasing the shutter speed of the imaging system to shorten the exposure time of the image sensor, or by decreasing the shutter speed to lengthen the exposure time, motion blur in the captured image can be controlled.

In case capturing the image capture target with the same motion, in case the exposure time of the imaging element is relatively long, motion blur becomes relatively large, and the captured image becomes a blurred image containing a large amount of motion blur. On the other hand, in case the exposure time of the imaging element is relatively short, motion blur becomes relatively small, and the captured image becomes a clear image with little motion blur. In other words, by controlling the exposure time, the motion blur that occurs can be controlled.

In addition, in case capturing images in the same imaging environment, in case the movement of the image capture target is relatively fast, motion blur becomes relatively large. In contrast, in case the movement of the image capture target is relatively slow, motion blur becomes relatively small.

### [2-2: Gait]

In a walking movement, the posture of a walker W changes. Hereinafter, the posture of the walker W performing the walking movement is referred to as “gait.”

Observing the walker W, for example, the posture in case one foot lands is approximately the same each time. The posture in case one foot lands in the current step is often similar to the posture in case the same foot landed in the previous step. Additionally, the posture in case one foot lands in the current step is likely to be similar to the posture in case the same foot lands in the next step. In other words, gait progresses cyclically. One cycle of gait may refer to the interval from in case one foot lands until the same foot lands again.

Since it is known that gait changes periodically, gait can be used to estimate the position of the walker W in the near future. Additionally, gait can be used to estimate the velocity associated with that position. The near future may refer to the timing of arrival at the predetermined location. Conversely, gait can be used to estimate when the predetermined location will be arrived.

In the walking movement, the walking speed of the walker W is not constant and varies depending on the gait. Furthermore, the walker W moves not only in a direction of movement but also in a direction perpendicular to the direction of movement. That is, the walker W has a velocity component in the direction perpendicular to the optical axis of the imaging system. The movement speed in this direction perpendicular to the direction of movement is also not constant and varies depending on the gait pattern. Such gait patterns can be used to estimate the speed associated with the predetermined location.

### [2-3: Example of Application of the Information Processing Apparatus 2]

The information processing apparatus 2 according to this embodiment is applied to imaging the target that moves. The information processing apparatus 2 according to this embodiment may be applied to imaging the walker W that moves by walking.

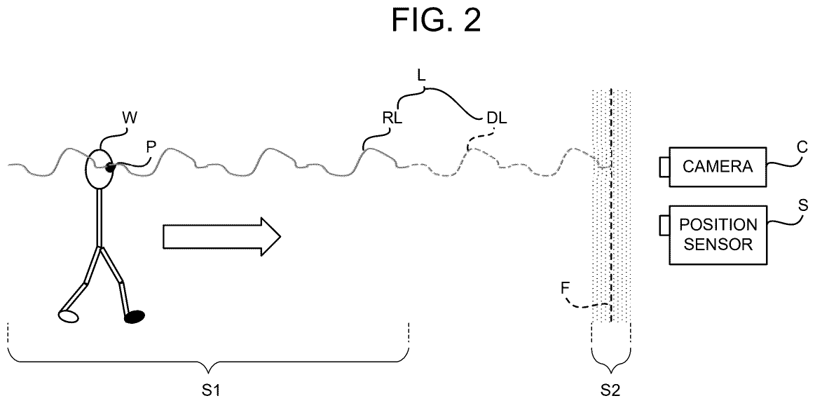

FIG. 2 illustrates an example of a scene where the information processing apparatus 2 is applied. As shown in FIG. 2, a camera C and a position sensor S are provided at a destination of the walker W. The camera C captures images of the walker W walking toward the camera C. The camera C is controlled to capture the walker W in case it arrives at the predetermined location S2. The predetermined location S2 is the location where the image is captured by the camera C. FIG. 2 illustrates a case where the walker W moves along the optical axis of the camera C. In FIG. 2, the direction of travel of the walker W indicated by the arrow is the horizontal direction.

The position sensor S measures the position of a predetermined part P of the walker W walking toward the camera C in three-dimensional space. In this embodiment, a range sensor may be used as the position sensor S. A three-dimensional camera may also be used as the position sensor S. Furthermore, a three-dimensional sensor may be used as the position sensor S. Additionally, a LiDAR (Laser Imaging Detection and Ranging) may be used as the position sensor S.

In case the walker W is at the predetermined location S2, the information processing apparatus 2 can acquire an image in focus with the walker W. That is, the predetermined location S2 is a location including a focal plane F where the focus of the camera C is aligned. The predetermined location S2 may be an area including the front and rear of the focal plane F. The predetermined location S2 may be a range in which the degree of blurring is less than a predetermined value.

The information processing apparatus 2 according to this embodiment estimates the speed of the walker W in case the walker W arrives at the predetermined location S2 based on the gait. Then, by controlling the imaging environment according to the estimated speed, an image including the desired motion blur is acquired.

By the way, even in case the gait is the same for the same person, it may differ depending on the situation. Therefore, the detected gait may vary each time the gait is detected. Therefore, the information processing apparatus 2 acquires the gait immediately before arriving at the predetermined location S2.

A gait detection section S1 is a section that detects the gait of the walker W walking toward the camera C. The gait detection section S1 is set behind the direction of travel of the walker W walking toward the camera C. The starting point of the gait detection section S1 may be set at a location separated from the focal plane F by a first predetermined distance. The end point of the gait detection section S1 may be set at a location separated from the focal plane F by a second predetermined distance shorter than the first predetermined distance. Alternatively, the end point of the gait detection section S1 may be specified at a location where the time taken for the walker W to arrive at the focal plane F is shorter than a predetermined time.

As mentioned above, since gait is periodic, future gait can be estimated based on past gait. The line L shown in FIG. 2 is an example of the displacement of the predetermined part P of the walker W. The predetermined part P of the walker W may be, for example, an eye of the walker W. As illustrated by the line L shown in FIG. 2, the displacement of the predetermined part P of the walker W is periodic. The displacement of the predetermined part P of the walker W corresponds to the gait of the walker W. For example, the position of the predetermined part P of the walker W varies with the same cycle as the gait of the walker W.

Furthermore, the solid line RL shown in FIG. 2 may be understood as detection results detected based on position information. The solid line RL shown in FIG. 2 may be understood as the trajectory of the predetermined part P of the walker W. Additionally, the dashed line DL shown in FIG. 2 may be understood as estimated results estimated based on the detection results indicated by the solid line RL.

### [2-4: Configuration of the Information Processing Apparatus 2]

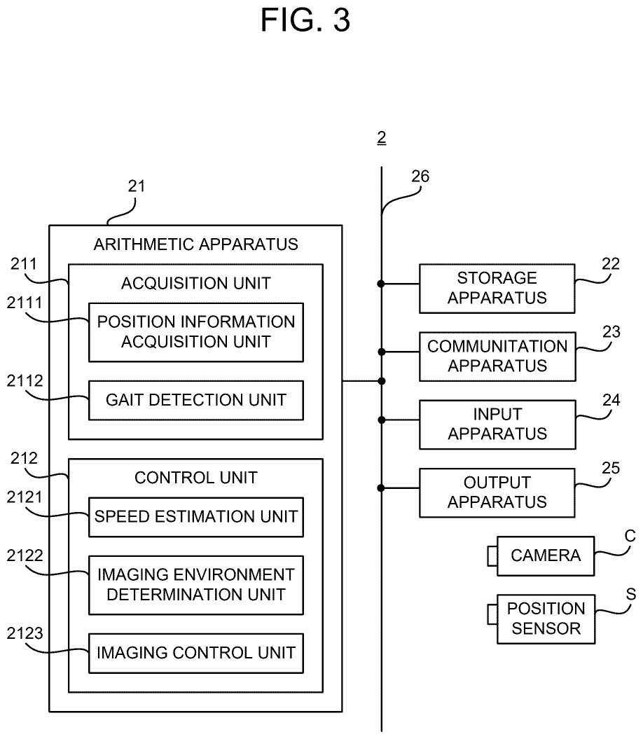

FIG. 3 is a block diagram showing the configuration of the information processing apparatus 2 according to the second embodiment. As shown in FIG. 3, the information processing apparatus 2 is provided with an arithmetic apparatus 21 and a storage apparatus 22. Furthermore, the information processing apparatus 2 may include a communication apparatus 23, an input apparatus 24, and an output apparatus 25. However, the information processing apparatus 2 may not include at least one of the communication apparatus 23, the input apparatus 24, and the output apparatus 25. The arithmetic apparatus 21, the storage apparatus 22, the communication apparatus 23, the input apparatus 24, and the output apparatus 25 may be connected via a data bus 26.

The arithmetic apparatus 21 may be, for example, a CPU (Central Processing Unit), a GPU (Graphics Processing Unit), and/or an FPGA (Field Programmable Gate Array). The arithmetic apparatus 21 reads a computer program. For example, the arithmetic apparatus 21 may read a computer program stored in the storage apparatus 22. For example, the arithmetic apparatus 21 may read a computer program stored in a computer-readable and non-temporary recording medium using a recording medium reading apparatus (e.g., the input apparatus 24 described later) provided in the information processing apparatus 2. The arithmetic apparatus 21 may acquire (i.e., download or read) a computer program from an apparatus not shown, which is disposed outside the information processing apparatus 2, via the communication apparatus 23 (or other communication apparatus). The arithmetic apparatus 21 executes the read computer program. As a result, logical functional blocks for executing the operations that the information processing apparatus 2 should perform are realized within the arithmetic apparatus 21. In other words, the arithmetic apparatus 21 functions as a controller for realizing logical functional blocks for executing the operations (i.e., processing) that the information processing apparatus 2 should perform.

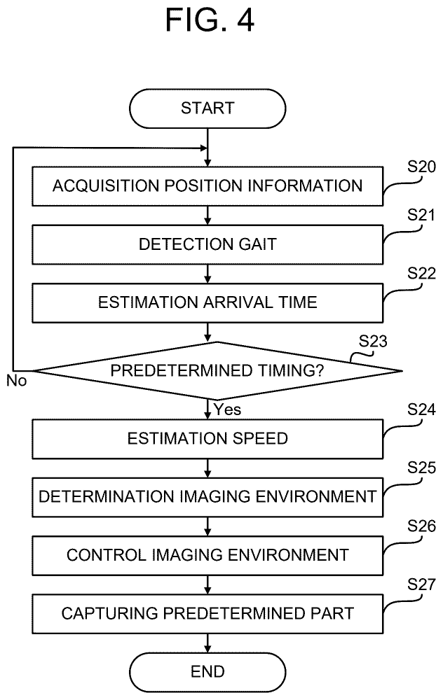

FIG. 3 shows an example of logical functional blocks realized within the arithmetic apparatus 21 for executing information processing operations. As shown in FIG. 3, the arithmetic apparatus 21 includes an acquisition unit 211, which is a specific example of the “acquisition unit” described in the Supplementary Note described later, and a control unit 212, which is a specific example of the “control unit” described in the Supplementary Note described later. The acquisition unit 211 may include a position information acquisition unit 2111 and a gait detection unit 2112. Additionally, the control unit 212 may include a speed estimation unit 2121, an imaging environment determination unit 2122, and an imaging control unit 2123. The details of the operation of the acquisition unit 211 and the control unit 212 will be explained later with reference to FIG. 4.

The storage apparatus 22 is capable of storing desired data. For example, the storage apparatus 22 may temporarily store the computer program executed by the arithmetic apparatus 21. The storage apparatus 22 may temporarily store data temporarily used by the arithmetic apparatus 21 in case the arithmetic apparatus 21 is executing the computer program. The storage apparatus 22 may store data that the information processing apparatus 2 stores for long-term preservation. Note that the storage apparatus 22 may be RAM (Random Access Memory), ROM (Read Only Memory), a hard disk apparatus, an optical magnetic disk apparatus, an SSD (Solid State Drive), and a disk array apparatus. In other words, the storage apparatus 22 may include a non-temporary recording medium.

The communication apparatus 23 is capable of communicating with an external apparatus of the information processing apparatus 2 via an unillustrated communication network. The communication apparatus 23 may be a communication interface based on standards such as Ethernet (registered trademark), Wi-Fi (registered trademark), Bluetooth (registered trademark), or USB (Universal Serial Bus).

The input apparatus 24 is an apparatus that accepts information input to the information processing apparatus 2 from outside the information processing apparatus 2. For example, the input apparatus 24 may include an operation apparatus (e.g., at least one of a keyboard, a mouse, and a touch panel) that can be operated by an operator of the information processing apparatus 2. For example, the input apparatus 24 may include a reading apparatus capable of reading information recorded as data on a recording medium that can be attached to the information processing apparatus 2.

The output apparatus 25 is an apparatus that outputs information to the outside of the information processing apparatus 2. For example, the output apparatus 25 may output information as images. In other words, the output apparatus 25 may include a display apparatus (a so-called display) capable of displaying images indicating the information to be output. For example, the output apparatus 25 may output information as sound. In other words, the output apparatus 25 may include an audio apparatus (i.e., a speaker) capable of outputting audio. For example, the output apparatus 25 may output information onto paper. In other words, the output apparatus 25 may include a printing apparatus (i.e., a printer) capable of printing desired information onto paper.

The camera C and the position sensor S may each be mounted on the information processing apparatus 2. Alternatively, the camera C and the position sensor S may each communicate with the information processing apparatus 2 via the communication apparatus 23 to exchange information.

### [2-5: Information Processing Operations Performed by the Information Processing Apparatus 2]

Referring to FIG. 4, the flow of information processing operations performed by the information processing apparatus 2 will be explained. FIG. 4 is a flowchart illustrating information processing operations performed by the information processing apparatus 2.

As shown in FIG. 4, the position information acquisition unit 2111 acquires position information indicating a position of the walker W in a three-dimensional space (step S20). The position information acquisition unit 2111 may acquire position information indicating the position of the predetermined part P of the walker W in the three-dimensional space. The position information acquisition unit 2111 may acquire position information indicating the position of the predetermined part P of the walker W using the position sensor S. As described above, the position sensor S measures the position in three-dimensional space of the predetermined part P of the walker W walking toward the camera C. The position information acquisition unit 2111 may acquire time-series position information of the predetermined part P of the walker W in three-dimensional space as position information.

FIG. 2 may be understood as a schematic diagram of the information processing operation performed by the information processing apparatus 2 according to the embodiment. FIG. 2 illustrates an example in which the position information acquisition unit 2111 acquires position information of the walker W located in the section of the gait detection section S1.

The gait detection unit 2112 detects the gait of the walker W based on the position information of the walker W in the three-dimensional space (step S21). The gait detection unit 2112 may track the predetermined part P of the walker W using the time-series position information of the predetermined part P of the walker W and determine the trajectory of the predetermined part P of the walker W.

The predetermined part P of the walker W may be the part captured by the camera C. The predetermined part P of the walker W may be the eye of the walker W. The gait detection unit 2112 may detect the trajectory of the predetermined part P of the walker W in three-dimensional space as the gait of the walker W.

The gait detection unit 2112 may detect the gait of the walker W based on the trajectory of the predetermined part P of the walker W. The gait detection unit 2112 may predict the information shown by the dashed line DL in FIG. 2 based on the information shown by the solid line RL in FIG. 2. The solid line RL in FIG. 2 illustrates measured results, and the dashed line DL may illustrate estimated results.

The gait detection unit 2112 may detect the gait pattern of the walker W. The gait detection unit 2112 may detect the periodic pattern of the gait.

The gait detection unit 2112 may recognize the walker W before the walker W arrives at the predetermined location S2 and detect the gait of the walker W. The gait detection unit 2112 may start detecting gait in case it recognizes the walker W arriving at the starting point of the gait detection section S1 located at the first predetermined distance from the focal plane F.

The gait detection unit 2112 may derive a model representing the position of the predetermined part P of the walker W. This model is referred to as a gait model. The gait detection unit 2112 may derive the gait model representing the trajectory of the predetermined part P of the walker W. The gait detection unit 2112 may derive the model representing the position of the predetermined part P of the walker W, for example, using amplitude and period as parameters. The gait detection unit 2112 may derive the model representing the vertical position of the predetermined part P of the walker W using parameters such as amplitude and period.

The gait detection unit 2112 may, for example, update the detected gait each time it recognizes at least one of the positive peak and negative peak of the vertical position of the predetermined part P of the walker W. The gait detection unit 2112 may, for example, perform filtering using a linear filter or the like.

In this way, by acquiring position information by the position information acquisition unit 2111 and detecting gait by the gait detection unit 2112, the acquisition unit 211 acquires gait information indicating the gait of the walker W that moves. The acquisition unit 211 predicts the timing t_{f} at which the walker W arrives at the predetermined location S2 based on the gait information acquired (step S22). The acquisition unit 211 may predict the timing tᵣ at which the walker W arrives at the predetermined location S2 based on, for example, the gait cycle of the walker W. In addition, the acquisition unit 211 may predict the time Δt_{f}(=tᵣ−t) required for the walker W to arrive at the predetermined location S2 using the predicted timing t_{f} at which the walker W arrives at the predetermined location S2 and the current timing t. In this case, the current timing may be, for example, the time when the gait detection unit 2112 updated the detected gait.

The acquisition unit 211 determines whether or not the timing is a predetermined timing (step S23). The predetermined timing may be when the time Δt_{f} required for the walker W to arrive at the predetermined location S2 is less than or equal to a predetermined time tₜₕ, as shown in the following equation 1. The predetermined time tₜₕ may be, for example, one cycle of the detected gait.

$$Δ {t}_{f} = {t}_{f} - t \leq {t}_{t h} \qquad [ Equation 1 ]$$

The position of the walker W at the predetermined timing may be the endpoint of the gait detection section S1 shown in FIG. 2. The repetitive operation from step S20 to step S23 may be performed during the period from in case the walker W arrives at the starting point of the gait detection section S1 until it arrives at the endpoint of the gait detection section S1. In other words, the gait detection unit 2112 detects the gait of the walker W during the time from in case the walker W starts at the starting point of the gait detection section S1 until it arrives at the end point of the gait detection section S1.

In case a timing is not the predetermined timing (step S23: No), return to step S20. The gait detection unit 2112 may repeat the detection of the gait and the update of the gait detected until the predetermined timing is reached.

In case a timing is the predetermined timing (step S23: Yes), the speed estimation unit 2121 estimates the speed of the walker W with respect to the focal plane F based on the gait information (step S24). Specifically, the speed estimation unit 2121 predicts the point where the focal plane F intersects with the gait model, which may also serve as the target position. The gait model may be a model representing a trajectory of the predetermined part P of the walker W, as described above. The speed estimation unit 2121 may estimate the velocity vector perpendicular to the optical axis of the camera C with respect to this target position. In other words, the speed estimation unit 2121 may estimate the velocity vector perpendicular to the optical axis of the camera C with respect to the walker W in the focal plane F. The speed estimation unit 2121 may estimate the absolute value of the velocity vector. The absolute value of the velocity vector may be simply referred to as “the speed v.”

The speed estimation unit 2121 may be rephrased as estimating the factors of motion blur. Motion blur occurs in case the image capture target has a velocity component in the direction perpendicular to the optical axis of the camera C during image capture. Therefore, the estimation of the speed v by the speed estimation unit 2121 can be rephrased as estimating the factors causing motion blur. The speed estimation unit 2121 may predict the speed v using, for example, a linear filter.

The imaging environment determination unit 2122 determines the imaging environment of the camera C based on the speed v estimated (step S24). The imaging environment determination unit 2122 may be rephrased as determining an imaging environment suitable for motion blur control based on the speed v estimated. For example, the predetermined timing tₜₕ may correspond to one cycle of the gait model. In this case, the imaging environment determination unit 2122 may determine the imaging environment in case a time until the walker W arrives at the predetermined location S2 is less than one cycle of the gait.

The imaging control unit 2123 controls the imaging environment of the camera C in accordance with the imaging environment determined (step S26). The imaging control unit 2123 may control, for example, the exposure amount during imaging as the imaging environment. In this case, the imaging control unit 2123 may control the exposure mechanism of the camera C. The imaging control unit 2123 may control the exposure time as the imaging environment. The imaging control unit 2123 may control the illumination intensity as the imaging environment. In addition, the imaging control unit 2123 may control the frame rate of the camera C as the imaging environment.

The imaging control unit 2123 controls the camera C to capture the predetermined part P of the walker W (step S27). In case the predetermined part P is an eye, the camera C may be an infrared camera. The imaging control unit 2123 may control the imaging environment and control capturing at the timing tᵣ when the walker W predicted in step S22 arrives at the predetermined location S2.

Note that the position measured by the position sensor S and the position within the field of view of the camera C are calculated as corresponding one-to-one, and the above-described information processing operations are performed.

Additionally, the acquisition unit 211 may not include the position information acquisition unit 2111 and the gait detection unit 2112. In this case, the acquisition unit 211 may acquire information indicating the gait of the walker W detected externally from the information processing apparatus 2. For example, in case the walker W is recognized as having arrived at the endpoint of the gait detection section S1, the acquisition unit 211 may acquire gait information indicating the gait of the walker W.

### [2-6: Technical Effects of the Information Processing Apparatus 2]

The information processing apparatus 2 according to the second embodiment can estimate the speed component that causes motion blur related to the focal plane F by detecting gait, and can capture the predetermined part P of the walker W in the appropriate imaging environment that controls motion blur. The information processing apparatus 2 estimates the factors causing motion blur in the focal plane F for each attempt and controls the imaging environment to be optimized for the estimated results, thereby enabling acquisition of images of the desired quality.

### 3: Third Example Embodiment

Next, the third embodiment of the information processing apparatus, information processing method, and recording medium will be described. In the following, the third embodiment of the information processing apparatus, information processing method, and recording medium will be described using a recognition system 3 to which the third embodiment of the information processing apparatus, information processing method, and recording medium is applied.

### [3-1: Configuration of the Recognition System 3]

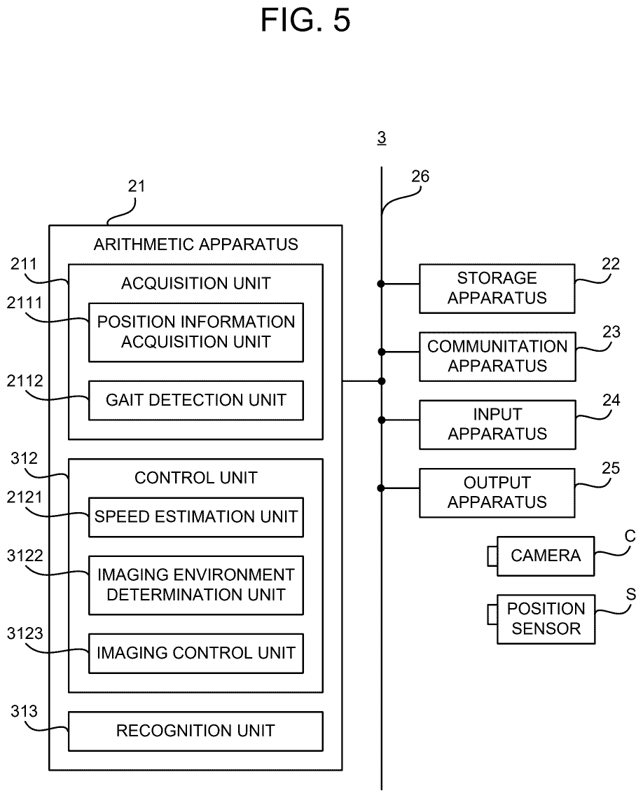

As shown in FIG. 5, the recognition system 3 according to the third embodiment is provided with the arithmetic apparatus 21 and the storage apparatus 22, as in the information processing apparatus 2 according to the second embodiment. Furthermore, the recognition system 3 according to the third embodiment may include the communication apparatus 23, the input apparatus 24, and the output apparatus 25, as in the information processing apparatus 2 according to the second embodiment. However, the recognition system 3 may not include at least one of the communication apparatus 23, the input apparatus 24, and the output apparatus 25. The recognition system 3 according to the third embodiment differs from the information processing apparatus 2 according to the second embodiment in that a recognition unit 313 is further provided in the arithmetic apparatus 21. The recognition unit 313 recognizes the walker W using the captured image of the walker W. The recognition unit 313 may be a mechanism that causes a recognition engine mounted on the recognition system 3 to recognize the walker W using the captured image. Other features of the recognition system 3 may be the same as other features of the information processing apparatus 2 according to the second embodiment. For this reason, the following description will focus on the parts that differ from the embodiment already described, and the other parts that are the same will be omitted as appropriate.

### [3-2: Application Scene]

The recognition system 3 according to this embodiment is applied to recognize of the target that moves. The recognition system 3 according to this embodiment may be applied to recognition of a walker W that moves by walking.

A recognition system that performs biometric recognition using a target image acquired from the camera C at that location by capturing the target that moves with the camera C is called a walk-through recognition system. The recognition system 3 according to this embodiment may be applied to the walk-through recognition system.

The biometric recognition using the target image acquired from the camera C may be iris recognition. That is, the recognition system 3 according to this embodiment may be applied to iris recognition of the walker W that moves by walking. In case the biometric recognition using the target image acquired from the camera C is iris recognition, the camera C may be an infrared camera. In addition, the biometric recognition using the target image acquired from the camera C may be face recognition. That is, the recognition system 3 according to this embodiment may be applied to face recognition of the walker W that moves by walking. The recognition system 3 according to this embodiment may be applied, for example, to secure personal recognition at airport immigration control.

The walk-through recognition system is a recognition system that can perform smooth recognition without requiring users of the recognition system to stop in front of the camera C in case of passing through the recognition system. Since users of the recognition system do not stop in front of the camera C, information such as the walking speed of users is useful for accurate recognition.

The gait of users of a walk-through iris recognition system varies with each recognition attempt. For example, even the gait of the same person may differ with each attempt. For example, the gait of a user who is in a hurry differs from that of a user who is not in a hurry. In addition, gait may vary depending on a physical condition of a user. Therefore, by detecting a gait of a user immediately before capturing with the camera C for each attempt, capturing with the camera C can be performed in the appropriate imaging environment for the corresponding attempt.

In case using images for the biometric recognition, it is advantageous to use images that appear to show a recognition target as stationary and do not contain motion blur. As mentioned above, in case imaging in the same imaging environment, motion blur becomes relatively large in case the movement of the image capture target is relatively fast. On the other hand, in case the movement of the image capture target is relatively slow, motion blur becomes relatively small. Additionally, in case of capturing the same image capture target that moves, reducing the exposure time of the imaging element results in smaller motion blur, yielding images with less motion blur and higher clarity. In other words, by adjusting the imaging environment parameters such as exposure time according to the movement of the image capture target, it is possible to acquire images suitable for the biometric recognition with minimal motion blur.

In addition, in case of using images for the biometric recognition, it is advantageous to use images with sufficient brightness. That is, images used for the biometric recognition are required to be sufficiently bright and free of motion blur. As mentioned above, the concept of “brightness” used in this embodiment and the concept of “brightness” perceived by the human eye are not necessarily the same.

To acquire images suitable for the biometric recognition, it is important to optimize the imaging environment, such as exposure time, to suppress motion blur and acquire images that are as bright as possible. In particular, in the iris recognition using near-infrared light, it is important to suppress motion blur while optimizing the imaging environment related to brightness, such as exposure time.

In case the exposure time is shortened, in case other factors in the imaging environment remain the same, the images captured by the camera C tend to become darker. In other words, in case the exposure time is shortened to reduce motion blur, the brightness of the image may become insufficient.

The brightness considered sufficient varies depending on the recognition engine used for biometric recognition. Therefore, even in case a brightness level is unacceptable for the biometric recognition for one recognition engine, it may be acceptable for another recognition engine.

On the other hand, in case the exposure time is increased to capture sufficiently bright images, motion blur increases. The amount of motion blur that is acceptable varies depending on the recognition engine that performs the biometric recognition. Therefore, even in case the amount of motion blur is unacceptable for use in the biometric recognition for one recognition engine, it may be acceptable for use in biometric recognition for another recognition engine.

### [3-3: Information Processing Operations Performed by the Recognition System 3]

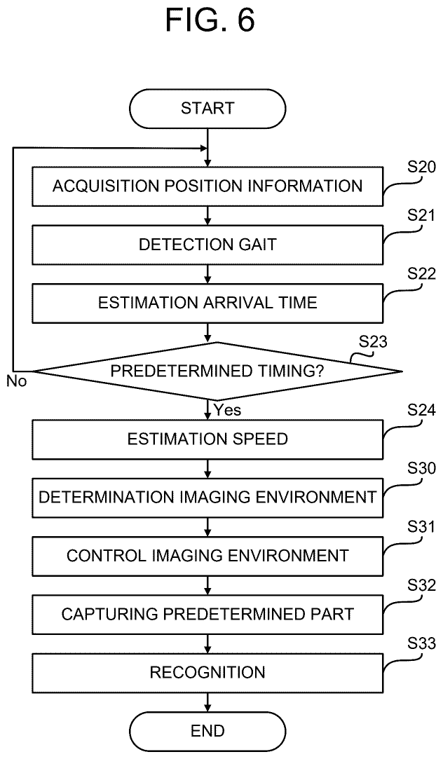

Referring to FIG. 6, the flow of information processing operations performed by the recognition system 3 will be explained. FIG. 6 is a flowchart showing the information processing operations performed by the recognition system 3.

As shown in FIG. 6, the position information acquisition unit 2111 acquires the position information indicating the position of the walker W in three-dimensional space (step S20). The gait detection unit 2112 detects the gait of the walker W based on the position information related to the three-dimensional space (step S21). The acquisition unit 211 predicts the timing tᵣ at which the walker W arrives at the predetermined location S2 based on the gait information acquired (step S22). The acquisition unit 211 determines whether or not a timing is the predetermined timing (step S23). The predetermined timing is in case the time Δt_{f} required for the walker W to arrive at the predetermined location S2 is less than or equal to the predetermined time tₜₕ, as shown in the above equation 1.

In case it is the predetermined timing (step S23: Yes), the speed estimation unit 2121 estimates the speed v of the walker W associated with the focal plane F based on the gait information (step S24). The speed estimation unit 2121 may estimate the velocity component that causes motion blur in the focal plane F based on the gait detected.

The imaging environment determination unit 3122 determines the imaging environment of the camera C according to the estimated speed v (step S30). In the third embodiment, the imaging environment determination unit 3122 may determine the imaging environment so that the camera C captures the target image suitable for recognition by the recognition unit 313. The imaging environment determination unit 3122 may determine the imaging environment so that the camera C captures the target image suitable for the recognition engine that performs the biometric recognition by the recognition unit 313. For example, an imaging control unit 3123 may control the imaging environment so that it captures images that are clear enough to be used for recognition by the recognition unit 313. For example, the imaging control unit 3123 may control the imaging environment so that it captures images that are clear enough to extract features of the walker W.

The imaging control unit 3123 controls the imaging environment so that the camera C captures the target image suitable for recognition by the recognition unit 313 in accordance with the imaging environment determined (step S31). The imaging control unit 3123 controls the camera C to capture the predetermined part P of the walker W (step S32). By this, the camera C can capture an image suitable for recognition.

The recognition unit 313 recognizes the walker W using the image captured of the walker W (S33). The recognition unit 313 may be rephrased as causing the recognition engine mounted on the recognition system 3 to perform the biometric recognition.

### [3-4: Technical Effects of the Recognition System 3]

The recognition system 3 according to the third embodiment controls the imaging environment so as to capture images captured suitable for recognition by the recognition unit 313, so that the recognition unit 313 can accurately recognize the walker W. The recognition system 3 can dynamically change the exposure time for each attempt according to the speed v estimated, so recognition can be performed using images with brightness suitable for recognition and with motion blur suppressed.

### 4: Fourth Example Embodiment

Next, the fourth embodiment of the information processing apparatus, information processing method, and recording medium will be described. In the following, the fourth embodiment of the information processing apparatus, information processing method, and recording medium will be described using a recognition system 4 to which the fourth embodiment of the information processing apparatus, information processing method, and recording medium is applied.

### [4-1: Information Processing Operations Performed by the Recognition System 4]

In the fourth embodiment, the operation of the recognition system 4 differs from that of the third embodiment. The amount of motion blur that is allowed depends mainly on the characteristics of the recognition unit 313 and the movement speed of the image capture target. Therefore, the imaging environment determination unit 4122 determines the imaging environment according to a recognition margin M and a speed v. In this embodiment, the amount of motion blur in an image that allows recognition by the recognition unit 313 is called the recognition margin M.

The recognition unit 313 performs biometric recognition using a recognition engine installed in the recognition system 4. Therefore, the recognition margin M can be rephrased as a quantity related to the amount of motion blur that can be recognized by the recognition engine installed in the recognition system 4. In other words, the recognition margin M may be rephrased as a quantity determined by the recognition engine installed in the recognition system 4. The recognition margin M may be a quantity dependent on the size of motion blur tolerated by the recognition engine. The recognition margin M may be a quantity determined by the performance of the recognition engine. The recognition margin M may be a quantity determined by the nature of the recognition engine.

The speed v used by the imaging environment determination unit 4122 may be the same quantity as the speed v acquired in the information processing apparatus 2 according to the second embodiment. The speed v used by the imaging environment determination unit 4122 may be the velocity component that causes motion blur in relation to the focal plane F. The speed v used by the imaging environment determination unit 4122 may be the absolute value of the velocity vector of the walker W that is orthogonal to the optical axis of the camera C in relation to the focal plane F.

### [4-2: Technical Effects of the Recognition System 4]

The recognition system 4 according to the fourth embodiment controls the imaging environment according to the amount of motion blur in the image, which can be recognized by the recognition unit 313, in addition to the speed v of the walker W, thereby enabling recognition using images suitable for recognition.

### 5: Fifth Example Embodiment

Next, the fifth embodiment of the information processing apparatus, information processing method, and recording medium will be described. In the following, the fifth embodiment of the information processing apparatus, information processing method, and recording medium will be described using a recognition system 5 to which the fifth embodiment of the information processing apparatus, information processing method, and recording medium is applied.

### [5-1: Information Processing Operation Performed by the Recognition System 5]

In the fifth embodiment, the operation of the imaging environment determination unit 5122 is different from that of the other embodiments described above. In the fifth embodiment, a specific method for determining the exposure time is described.

### [5-2: Exposure Time Determination Rule]

In the fifth embodiment, the imaging environment determination unit 5122 determines an actual exposure time E as the imaging environment in accordance with the exposure time determination rule described below. The exposure time determination rule is a method for determining the actual exposure time E and uses a function. The exposure time determination rule according to the fifth embodiment uses a function of the recognition margin M and the speed v. The recognition margin M may be a parameter related to the amount of motion blur allowed by a recognition engine installed in the recognition system 5.

The exposure time determination rule according to the fifth embodiment may use a function that uses, in addition to the recognition margin M and the speed v, a resolution A of an image captured by the camera C as input. It is known that motion blur occurs depending on the resolution A of the image captured. In addition, the exposure time determination rule according to the fifth embodiment may set a minimum exposure time Eₘᵢₙ for imaging that provides the brightness of the image required by the recognition engine as the lower limit of the actual exposure time E.

Each parameter used in the exposure time determination rule according to the fifth embodiment is described below. The parameters used in the exposure time determination rule include parameters that can be acquired in advance and parameters that are acquired for each attempt.

The parameters that can be acquired in advance include the minimum exposure time Eₘᵢₙ, the resolution A, and the recognition margin M. The parameters that can be acquired in advance may be parameters determined by the recognition engine installed in the recognition system 5. In the fifth embodiment, the illumination intensity during imaging may be a fixed value.

The minimum exposure time Eₘᵢₙ [s] is the exposure time that can provide the brightness of the image required by the recognition engine during imaging. The minimum exposure time Eₘᵢₙ can be rephrased as the exposure time required to maintain the minimum brightness necessary for recognition. The minimum exposure time Eₘᵢₙ can be rephrased as the lower limit of the exposure time that provides the amount of light required by the recognition engine.

The resolution A [m/pix] is the resolution of the image captured by the camera C. The resolution A is a parameter that can be determined from the resolution of the camera C and the focal point of the camera C. The resolution A may be set to comply with recognition by the recognition engine.

The recognition margin M may be a parameter related to the amount of motion blur that can be recognized by the recognition unit 313. The recognition margin M may be a value related to the motion blur tolerance specific to the recognition engine installed in the recognition system 5.

The recognition margin M may take a value of 1.0 or greater. The recognition margin M is a parameter that depends on the scale of motion blur allowed in recognition. The recognition margin M may be determined by performing a statistical learning process with various perturbations of its value to acquire the highest performance.

The recognition margin M may be a parameter that can be acquired in advance, or it may be a parameter that varies depending on the required recognition performance. For example, the recognition margin M may be a parameter acquire for each attempt.

Furthermore, the resolution A may be a parameter that can be determined based on the performance required for recognition. In other words, the resolution A may be a parameter determined for each attempt.

In the fifth embodiment, the parameters acquired for each attempt include parameters related to gait. The parameters related to gait are parameters estimated from the gait detected. The exposure time determination rule uses the speed v as the parameter related to gait. The speed v may be an estimated value of the velocity component of the position of the predetermined part P of the walker W at the predetermined location S2, calculated from the gait detected. The speed v may also be the absolute value of the velocity vector of the position of the predetermined part P of the walker W perpendicular to the optical axis of the camera C.

In case the movement component during the exposure time is less than half a pixel, the movement of the image capture target is not reflected. The state where the movement component during the exposure time is less than half a pixel is called no blur. The no blur condition that satisfies the no blur condition may be expressed by the following equation 2.

$$v \times E \leq A \times 0.5 \qquad [ Equation 2 ]$$

Using the recognition margin M, an optimal exposure time E* is determined such that the no complete blur condition expressed by the above Equation 2 is satisfied. The function for determining the optimal exposure time E* may be expressed by the following Equation 3.

$${E}^{*} = A \times 0.5 \times M \times ( 1 / v ) \qquad [ Equation 3 ]$$

The function expressed by the above equation 3 outputs the optimal exposure time E* in case each parameter is input. An imaging environment determination unit 5122 can determine the optimal exposure time E* using this function.

Furthermore, the actual exposure time E is determined so as to satisfy the minimum exposure time Eₘᵢₙ. In this case, the function expressed by the following equation 4 may also be used.

$$E = max ( {E}_{min} , {E}^{*} ) \qquad [ Equation 4 ]$$

In other words, the imaging environment determination unit 5122 adopts the larger of the minimum exposure time Eₘᵢₙ and the optimal exposure time E* as the actual exposure time E. That is, the imaging environment determination unit 5122 sets the exposure time that provides the brightness for imaging that can be recognized by the recognition unit 313 as the lower limit, and uses a function of the parameter related to the amount of motion blur that can be recognized by the recognition unit 313 and the speed v to determine the exposure time of the camera C as the imaging environment of the camera C.

### [5-3: Technical Effects of the Recognition System 5]

The recognition system 5 according to the fifth embodiment determines the exposure time appropriate for imaging as the imaging environment, so that images with brightness suitable for recognition can be captured, including images containing motion blur that can be recognized.

### 6: Sixth Example Embodiment

Next, the sixth embodiment of the information processing apparatus, information processing method, and recording medium will be described. In the following, the sixth embodiment of the information processing apparatus, information processing method, and recording medium will be described using an information processing apparatus 6 to which the sixth embodiment of the information processing apparatus, information processing method, and recording medium is applied.

### [6-1: Information Processing Operations Performed by the Information Processing Apparatus 6]

In the sixth embodiment, the information processing apparatus 6 has different operations for an imaging environment determination unit 6122 and an imaging control unit 6123. Depending on the timing of the information processing operations performed by the information processing apparatus 6, there may be a plurality of appropriate imaging environments. In case there is not just one appropriate imaging environment but a plurality of candidate imaging environments, it may not be possible to determine which the imaging environment will yield the optimal captured image without actually performing imaging. In such cases, the information processing apparatus 6 may attempt imaging using each of the imaging environments.

For example, the parameters of the exposure time determination rule described in the fifth embodiment, such as the recognition margin M and the speed v, may not be uniquely determined depending on the timing of the information processing operation. For example, in case the desired recognition performance is not uniquely determined, the recognition margin M is not uniquely determined. In this case, the actual exposure time E derived by the exposure time determination rule is also not uniquely determined. In addition, the speed v of the walker W in case the walker W arrives at the predetermined location S2 estimated based on the detected gait may have a range. In this case, the exposure time determination rule leads to a range for the actual exposure time E. In such a case, the exposure time may be changed for each image.

In the sixth embodiment, the imaging control unit 6123 controls the camera C to take a plurality of images of the walker W located at the predetermined location S2. In case the camera C captures video, the imaging environment determination unit 6122 determines the frame rate of the camera C such that a plurality of video frames include the walker W at the predetermined location S2, and the imaging control unit 6123 may control the camera C to capture at that frame rate. For example, the imaging environment determination unit 6122 may determine the frame rate of the camera C so that video frames containing the walker W at the predetermined location S2 can be acquired as many times as the number of candidates for the imaging environment estimated to be appropriate.

The imaging control unit 6123 controls the imaging environment for each image capture by the camera C. The imaging control unit 6123 may control the imaging environment for each video frame. Control for each image captured by the camera C refers to control for each shutter release, and when the camera C captures video, it refers to control for each video frame. The imaging control unit 6123 may switch between the plurality of appropriate candidates for the imaging environment for each image captured by the camera C.

For example, in case it is not possible to narrow down the exposure amount suitable for capturing images used for the biometric recognition to a single exposure amount, the possibility of acquiring images that can be recognized can be increased by acquiring images imaged with a plurality of exposure amounts. The imaging control unit 6123 may change the exposure time so that, for example, the exposure amount changes for each capturing by the camera C. The imaging control unit 6123 may switch the exposure time for each image captured by the camera C so that a plurality of exposure values are used.

### [6-2: Technical Effects of the Information Processing Apparatus 6]

The information processing apparatus 6 according to the sixth embodiment controls the imaging environment for each image capture, and the camera C can capture images in different imaging environments for each image capture, thereby improving the possibility of acquiring images captured in an appropriate imaging environment.

### 7: Seventh Example Embodiment

Next, the seventh embodiment of the information processing apparatus, information processing method, and recording medium will be described. In the following, the seventh embodiment of the information processing apparatus, information processing method, and recording medium will be described using an information processing apparatus 7 to which the seventh embodiment of the information processing apparatus, information processing method, and recording medium is applied.

### [7-1: Information Processing Operation Performed by the Information Processing Apparatus 7]

In the seventh embodiment, the information processing apparatus 7 has different operations of an imaging environment determination unit 7122 and an imaging control unit 7123. In the seventh embodiment, the imaging environment determination unit 7122 may determine the imaging environment that suppresses motion blur and the imaging environment that captures bright images. In the seventh embodiment, the imaging control unit 7123 may switch between determining the imaging environment that suppresses motion blur and the imaging environment that captures bright images. The imaging control unit 7123 may switch between the imaging environment that suppresses motion blur and the imaging environment that captures bright images for each image captured by the camera C.

For example, the imaging control unit 7123 may control the exposure time of the camera C during imaging to suppress motion blur in the captured image. The imaging control unit 7123 may also control the exposure time of the camera C during imaging to capture bright images.

For example, the optimal exposure time E* calculated by equation 3 described in the fifth embodiment may be less than the minimum exposure time Eₘᵢₙ. In this case, the control unit 712 according to the seventh embodiment may switch between controlling the exposure time as the imaging environment to be the minimum exposure time Eₘᵢₙ and controlling the exposure time as the imaging environment to be the exposure time calculated by equation 3 for each imaging by the camera C. This makes it possible to capture images under different conditions for each motion picture frame, thereby acquiring both images with suppressed motion blur and images with sufficient brightness. At least one of the images with suppressed motion blur and the images with sufficient brightness may be suitable for recognition, thereby increasing the possibility of acquiring images suitable for recognition.

### [7-2: Technical Effects of the Information Processing Apparatus 7]

The information processing apparatus 7 according to the seventh embodiment can acquire images with suppressed motion blur and bright images. In other words, the information processing apparatus 7 can acquire images containing motion blur that can be recognized and images with sufficient brightness for recognition.

### 8: Eighth Example Embodiment

Next, the eighth embodiment of the information processing apparatus, information processing method, and recording medium will be described. In the following, the eighth embodiment of the information processing apparatus, information processing method, and recording medium will be described using an information processing apparatus 8 to which the eighth embodiment of the information processing apparatus, information processing method, and recording medium is applied.

### [8-1: Information Processing Operation Performed by the Information Processing Apparatus 8]

In the eighth embodiment, the information processing apparatus 8 has different operations of an imaging environment determination unit 8122 and an imaging control unit 8123. In the eighth embodiment, the lighting used during imaging can be controlled by a control unit 812.

In the eighth embodiment, the control of the imaging environment may be adjustment of the amount of exposure received by the image pickup element. In the eighth embodiment, the control of the imaging environment may include at least one of control of the exposure time and control of the illumination intensity. In the eighth embodiment, the illumination intensity may be controlled in addition to or instead of the exposure time.

The exposure time and the illumination intensity are complementary to each other. In the eighth embodiment, the exposure time may be fixed at an appropriate value E_{def}, and the illumination intensity may be increased by a magnification corresponding to the ratio (Eₘᵢₙ/E*) of the optimal exposure time calculated. In other words, the illumination intensity may be varied in a manner complementary to the exposure time.

The imaging environment determination unit 8122 may determine the imaging environment such that, in case the optimal exposure time E* determined based on conditions for suppressing motion blur falls below the minimum exposure time Eₘᵢₙ, the illumination intensity L is increased as expressed by the following equation 5 to compensate for the decrease in brightness caused by the reduction in exposure time.

$$L = {L}_{def} \times ( {E}_{min} / {E}^{*} ) \qquad [ Equation 5 ]$$

The imaging control unit 8123 controls the exposure time and illumination intensity in accordance with the imaging environment determined by the imaging environment determination unit 8122, thereby controlling the imaging performed by the camera C.

### [8-2: Technical Effects of the Information Processing Apparatus 8]

The information processing apparatus 8 according to the eighth embodiment controls the illumination intensity according to the exposure time, so that imaging can be performed with an appropriate amount of exposure.

### 9: Supplementary Note

The following supplementary note is disclosed regarding the embodiments described above.

### [Supplementary Note 1]

An information processing apparatus including:
an acquisition unit that acquires gait information indicating a gait of a target that moves; and
a control unit that estimates a speed of the target in case the target arrives at a predetermined location based on the gait information, and controls an imaging environment for imaging the target having arrived at the predetermined location in accordance with the speed.

### [Supplementary Note 2]

The information processing apparatus according to Supplementary Note 1, wherein the acquisition unit includes:
a position information acquisition unit that acquires position information indicating a position of a predetermined part of the target in three-dimensional space; and
a gait detection unit that detects the gait of the target based on the position information,
the control unit estimates the speed of the target in case the target arrives the predetermined location based on the gait information and controls the imaging environment in accordance with the speed, and
an imaging unit having a focus at the predetermined location that captures the predetermined part of the target.

### [Supplementary Note 3]

The information processing apparatus according to Supplementary Note 2, further comprising
a recognition unit that performs a recognition the target using a target image of the target, wherein
the control unit controls the imaging environment so that the imaging unit captures the target image suitable for the recognition by the recognition unit.

### [Supplementary Note 4]

The information processing apparatus according to Supplementary Note 3, wherein
the imaging environment is an environment related to brightness at the time of imaging and includes an exposure time at the time of imaging, and
the control unit determines an exposure time as the imaging environment by using a function of an amount related to a magnitude of motion blur in the target image and the speed, with a lower limit exposure time being an exposure time at the time of imaging at which the recognition by the recognition unit is possible.

### [Supplementary Note 5]

The information processing apparatus according to Supplementary Note 4, wherein
the imaging environment is an environment related to brightness during imaging, and includes the exposure time during imaging, and
the determination unit, using a function of the amount related to the magnitude of the motion blur and the speed, determines the exposure time as the imaging environment, with the exposure time during imaging at which recognition by the recognition unit is possible as the lower limit exposure time.

### [Supplementary Note 6]

The information processing apparatus according to Supplementary Note 2, wherein
the imaging unit captures images at least twice, and
the control unit controls the imaging environment for each capturing by the imaging unit.

### [Supplementary Note 7]

The information processing apparatus according to Supplementary Note 2, wherein
the imaging unit captures images at least twice, and
the control unit switches between an imaging environment that suppresses motion blur and an imaging environment that captures a bright image for each capturing by the imaging unit.

### [Supplementary Note 8]

The information processing apparatus according to Supplementary Note 1 or 2, wherein
the imaging environment is an environment related to brightness at the time of imaging, and includes an exposure time at the time of imaging and an illumination intensity at the time of imaging; and
the control unit controls the illumination intensity in accordance with the exposure time.

### [Supplementary Note 9]

An information processing method including:
acquiring gait information indicating a gait of a target that moves;
estimating a speed of the target in case the target arrives at a predetermined location based on the gait information; and
controlling an imaging environment for imaging the target having arrived at the predetermined location in accordance with the speed.

### [Supplementary Note 10]

A recording medium on which a computer program is stored, the computer program being configured to allow a computer to execute an information processing method including:
acquiring gait information indicating a gait of a target that moves;
estimating a speed of the target in case the target arrives at a predetermined location based on the gait information; and
controlling an imaging environment for imaging the target having arrived at the predetermined location in accordance with the speed.

This disclosure may be changed as appropriate within the scope that does not contradict the technical idea that can be read from the claims and the entire description. The information processing apparatus, information processing method, and recording medium with such changes are also included in the technical idea of this disclosure.

### DESCRIPTION OF REFERENCE CODES

1, 2, 6, 7, 8 information processing apparatus
11, 211 acquisition unit
12, 212, 312, 412, 512, 612, 712, 812 control unit
C camera
S position sensor
2111 position information acquisition unit
2112 gait detection unit
2121, 3121 speed estimation unit
2122, 3122, 4122, 5122, 6122, 7122, 8122 imaging environment determination unit
2123, 3123, 6123, 7123, 8123 imaging control unit
3, 4, 5 recognition system
313 recognition unit
W walker
P predetermined part
F focal plane
S2 predetermined location
S1 gait detection section

What is claimed is:

1. An information processing apparatus comprising:
at least one memory storing instructions; and
at least one processor that is configured to execute the instructions to:
acquire gait information indicating a gait of a target that moves; and
estimate a speed of the target in case the target arrives at a predetermined location based on the gait information; and
control an imaging environment for imaging the target having arrived at the predetermined location in accordance with the speed.

2. The information processing apparatus according to claim 1, the at least one processor that is configured to execute the instructions to:
acquire position information indicating a position of a predetermined part of the target in three-dimensional space;
detect the gait of the target based on the position information;
estimate the speed of the target in case the target arrives the predetermined location based on the gait information;
control the imaging environment in accordance with the speed; and
capture the predetermined part of the target by a camera having a focus at the predetermined location.

3. The information processing apparatus according to claim 2, the at least one processor that is configured to execute the instructions to:
perform a recognition the target using a target image of the target; and
control the imaging environment so that the camera captures the target image suitable for the recognition.

4. The information processing apparatus according to claim 3, wherein
the imaging environment is an environment related to brightness at the time of imaging and includes an exposure time at the time of imaging, and
the at least one processor that is configured to execute the instructions to determine an exposure time as the imaging environment by using a function of an amount related to a magnitude of motion blur in the target image and the speed, with a lower limit exposure time being an exposure time at the time of imaging at which the recognition is possible.

5. The information processing apparatus according to claim 2, the at least one processor that is configured to execute the instructions to:
capture images at least twice by the camera; and
control the imaging environment for each capturing by the camera.

6. The information processing apparatus according to claim 2, the at least one processor that is configured to execute the instructions to:
capture images at least twice by the camera; and
switch between an imaging environment that suppresses motion blur and an imaging environment that captures a bright image for each capturing by the camera.

7. The information processing apparatus according to claim 1, wherein
the imaging environment is an environment related to brightness at the time of imaging, and includes an exposure time at the time of imaging and an illumination intensity at the time of imaging; and
the at least one processor that is configured to control the illumination intensity in accordance with the exposure time.

8. An information processing method comprising:
acquiring gait information indicating a gait of a target that moves;
estimating a speed of the target in case the target arrives at a predetermined location based on the gait information; and
controlling an imaging environment for imaging the target having arrived at the predetermined location in accordance with the speed.

9. A non-transitory recording medium on which a computer program is stored, the computer program being configured to allow a computer to execute an information processing method comprising:
acquiring gait information indicating a gait of a target that moves;
estimating a speed of the target in case the target arrives at a predetermined location based on the gait information; and
controlling an imaging environment for imaging the target having arrived at the predetermined location in accordance with the speed.
